(19) United States
(12) Patent Application Publication
(10) Pub. No.: US 2026/0024025 A1
(43) Pub. Date: Jan. 22, 2026

(54) PREDICTING USER RECEPTIVITY USING GESTURE ANALYSIS

(71) Applicant: Emaww, Longueuil (CA)

(72) Inventors: Alicia Heraz, Longueuil (CA); Kiran Kumar Ashish Bhyravabhottla, Longueuil (CA); Onofrei Constantin, Longueuil (CA)

(21) Appl. No.: 19/274,327

(22) Filed: Jul. 18, 2025

Related U.S. Application Data
(60) Provisional application No. 63/673,499, filed on Jul. 19, 2024.

(51) Int. Cl. G06N 20/20

(52) U.S. Cl. CPC G06N 20/20

(57) ABSTRACT

Methods, systems, and apparatus, including computer programs encoded on computer storage media, for predicting a user's receptivity. In some implementations, a system obtains data indicative of a time evolving movement of a user with a website shown on the client device. The system determines, using a first trained machine learning model, a likelihood for each of a set of emotions of the user associated with the interactions of the user with the website. The system extracts, from the website, a plurality of visible features from the website. The system provides, to a second trained machine learning model, (i) the determined likelihood for each of the set of emotions and (ii) data that represents the plurality of visible features. In response, the system generates, using the second trained machine learning model, a prediction indicating a receptivity score of the user associated with the website.

### CROSS-REFERENCE TO RELATED APPLICATION

This application claims the benefit of U.S. Provisional Application No. 63/673,499 filed on Jul. 19, 2024, which is incorporated herein by reference.

### TECHNICAL FIELD

This specifications describes technologies to predict a user's receptivity to website content using gesture analysis.

### BACKGROUND

Individuals attempt to characterize their emotional state, and to unlock and better understand not only their expressed emotions, but the underlying causes of the expressed emotions. Further, individuals attempt to share indicia of their emotional state based on graphical representations, such as an emoji shared by an individual across a text-messaging platform or among linked members of a social network.

### SUMMARY

This specification describes techniques that predict a user's receptivity to content presented on a website according to the user's expressed emotional experience, which is determined by analyzing the user's interaction with the website content. In some implementations, a system utilizes a non-intrusive approach to measure a user's receptivity to website content from the emotions they expressed on a particular website. For instance, the non-intrusive method includes measuring, for example, a touch gesture on a device that corresponds to a user emotion. The system can monitor touch gesture interactions of the user with the website through a display of a client device, a personalized computer, a tablet, or the like. The system utilizes a technique that receives a time-evolving, expressive, free-form of one or more portions of an individual's body and further generates a representation of the of the expressed emotion.

An expressed emotion may reflect a natural, instinctive state of mind deriving from the individual's circumstances, mood, or relationships with other individuals, and may include, but are not limited to, anger, awe, desire, fear, grief, hate, laughter, love, and scurry. Each of the expressed emotions may be correlated or associated with a detectable intensity. Based on the detected expressed emotion and the corresponding intensity, the system can better analyze the sub-conscious nature of touch gestures and gather emotional data, which allows for a more authentic and unbiased user interaction with websites.

In some implementations, E-learning websites offer a flexible environment for studying and provide access to educational resources globally. The focus of e-learning websites is to improve user receptivity. Previous technologies have relied on multimedia integration, content organization, and interactive features, but these platforms have not adequately captured users' attention and improved their experience. The techniques described in this specification aim to enhance online experiences by analyzing factors influencing website receptivity and providing recommendations for various websites.

In some implementations, the disclosed techniques include a system that utilizes an artificial intelligence machine learning (AI/ML) model trained to analyze the diverse content structures influencing website receptivity. The trained AI/ML model can produce this prediction with high accuracy, enhanced understanding of user receptivity, and provides new avenues for optimizing user experience with the website. Moreover, the use of the trained AI/ML model allows the system to provide actionable recommendations for enhancing user receptivity, suggesting changes in content, layout, style, and colors, to name a few examples.

The techniques described in this specification include data collection, feature selection, training and testing of the AI/ML model and deployment of the AI/ML model. For data collection, the system can collect real-time emotion data from a live website. The data is obtained with user consent, and privacy is ensured. The system can extract features from the collected data, which involves calculating users' receptivity and extracting web pages' properties. In some cases, the trained AI/ML model indicates that users are considered receptive towards the content of a web page if they are focused for a predetermined period of time. The properties of web pages are related to their content and style. The training and testing utilize various machine learning techniques, and their performance is evaluated using accuracy, recall, F1-score, precision, and ROC curve.

In one general aspect, a method is performed by one or more computers, such as a server. The method includes: obtaining, from a client device, data indicative of a time evolving movement of interactions of a user with website shown on the client device; determining, using a first trained machine learning model and based on the data indicative of the time evolving movement of interactions of the user with the website, a likelihood for each of a set of emotions of the user associated with the interactions of the user with the website; extracting, from the website, a plurality of visible features corresponding to content that characterize the website; providing, to a second trained machine learning model, (i) the determined likelihood for each of the set of emotions of the user and (ii) data that represents the plurality of visible features corresponding to content that characterize the website; in response to the providing, generating, using the second trained machine learning model, a prediction indicating a receptivity score of the user associated with the website; and providing, to one or more devices, data representing the prediction as output.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, obtaining the data indicative of the time evolving movement of interactions of the user with the website shown on the client device further includes: determining normalized values for the data indicative of the time evolving movement; and generating feature values that characterize the normalized values, wherein the generated feature values comprise at least one of speed, acceleration, contact duration, a change in contact pressure, or a finger size.

In some implementations, obtaining the data indicative of the time evolving movement of interactions of the user with the website shown on the client device further includes: obtaining, from the client device, the data indicative of the time evolving movement of a portion of a body of the user with the interactive site shown on the client device, wherein the portion of the body comprises a finger and the client device comprises a touchscreen display.

In some implementations, determining, using a first trained machine learning model and based on the data indicative of the time evolving movement of interactions of the user with the website, a likelihood for each of a set of emotions of the user associated with the interactions of the user with the website includes obtaining, from the first trained machine learning model, a vector that includes a plurality of emotions and the likelihood for each emotion of the plurality of emotions, wherein each likelihood represents how likely a corresponding emotion represents the data indicative of the time evolving movement of the user.

In some implementations, extracting, from the website, a plurality of visible features that characterize the website includes: extracting, from the website, a number of colors, a number of images, a number of paragraphs, and number of words; and storing, in a database, the number of colors, the number of images, the number of paragraphs, and the number of words for the interactive site.

In some implementations, extracting, from the website, a number of colors, a number of images, a number of paragraphs, and number of words includes parsing, from the website, Hypertext Markup Language (HTML) using a scraper to retrieve the number of colors, the number of images, the number of paragraphs, and the number of words.

In some implementations, the second trained machine learning model comprises a Light Gradient Boosting Machine.

In some implementations, generating, using the second trained machine learning model, a prediction indicating a receptivity score of the user associated with the website includes: generating, using the second trained machine learning model, the receptivity score that indicates the likelihood that the user is receptive to the content displayed on the website; comparing the receptivity score to a threshold value; determining whether the receptivity score satisfies the threshold value; and in response to determining that the receptivity score satisfies the threshold value, classifying the user's interaction with the website as receptive; or in response to determining that the predication score does not satisfy the threshold value, classifying the user's interaction with the website as non-receptive.

In some implementations, generating, using the second trained machine learning model, a prediction indicating a receptivity score of the user associated with the website includes generating, using the second trained machine learning model, the prediction indicating the receptivity score that the user is receptive to the website during a single user session with the website.

In some implementations, the data that represents the plurality of visible features that characterize the website includes (i) a user ID, (ii) a session ID, (iii) a time interval, (iv) a number of colors on the website, (v) a number of images on the website, (vi) a number of paragraphs on the website, and (vii) a number of words on the website.

In some implementations, the time interval comprises a time of day for when the user interacted with the website.

In some implementations, the data indicative of the time evolving movement comprises a plurality of contacts established sequentially between a finger of the user and a surface of a touchscreen display of the client device at corresponding contact times, wherein the plurality of contacts comprises contact positions, contact pressures, and the contact times associated with each of the contacts.

The subject matter described in this specification can be implemented in various embodiments and may result in one or more of the following advantages. In some implementations, the system provides technical advancements that include predicting a user's receptivity with a displayed website using gesture detection. Specifically, the system can predict emotional features from the gesture detection using one or more trained machine learning models. The predicted emotional features can be further processed by one or more additional trained machine learning models to predict the user's receptivity with the website. This process improves prediction accuracy for user receptivity likelihood through a user's behavioral analysis over a period of time.

In some cases, the system can recommend adjustments to a website to improve a likelihood of a user's receptivity with that website. The system can analyze data associated with other websites that were detected to have a high likelihood of user receptivity according to detected gestures. This data can include, for example, website layouts, website color schemes, information presentation on the website, and notification location/types, to name some examples. If the system detects a website where a particular gesture resulted in a low receptivity score, the system can determine whether that website with the low receptivity score includes one or more of the features from the other websites. If the system determines the website with the low receptivity score lacks one or more of these features from the other websites, the system can recommend adjustments to a designer of the website in order to improve its likelihood of users receptivity.

In some implementations, the system can perform automatic adjustments to the website to improve user receptivity using a browser extensions. In some cases, the browser extension can be utilized locally on a client device to adjust portions, e.g., colors, layout, text, and others, of the website without changing the content of the website on a backend server. These changes are performed locally on the client device. In some cases, the browser extension can perform automatic adjustments to the website that reflect changes to the website on the backend server. These changes can be performed in response to a user recommendation, the system determining changes to improve user receptivity, or other triggers. The browser extension can be, for example, a chatbot, an additional application, or another software program for performing adjustments to the website to improve user receptivity.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram that illustrates an example of a system for predicting a user's receptivity to a website according to gesture based emotion recognition.

FIG. 1B is a block diagram that illustrates an example of processes for predicting a user's receptivity to a website.

FIG. 2 illustrates ROC curves for different classes.

FIG. 3 is a flow diagram that illustrates a process for predicting a user's receptivity to a website according to gesture based emotion recognition.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

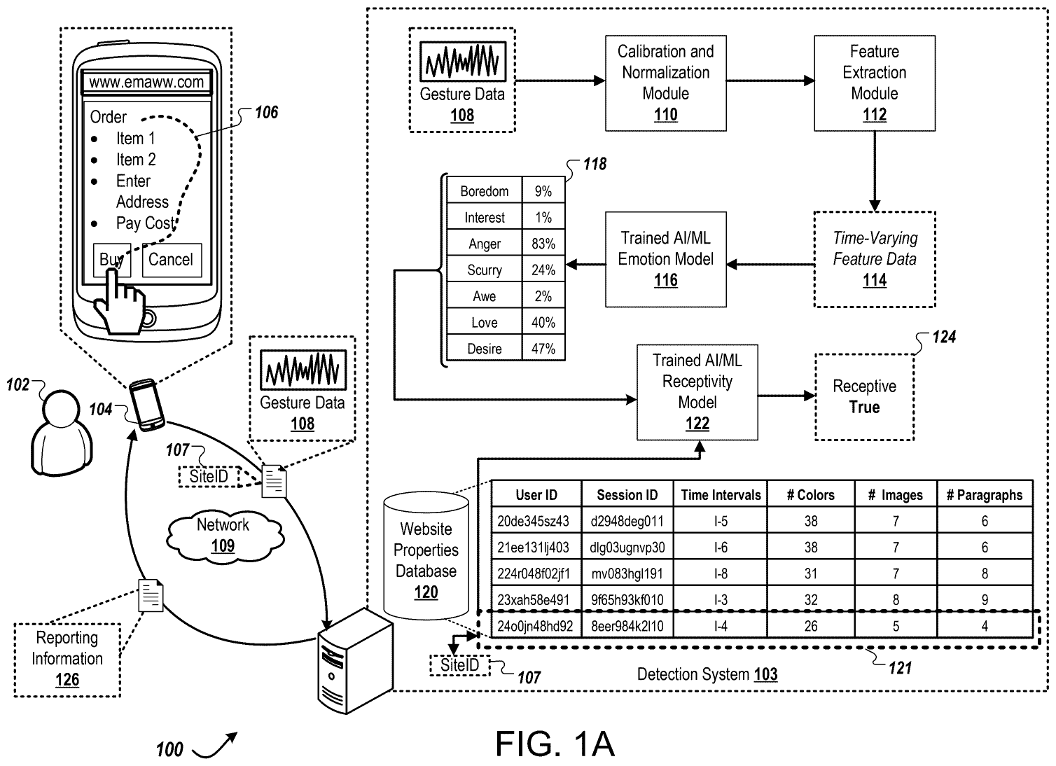

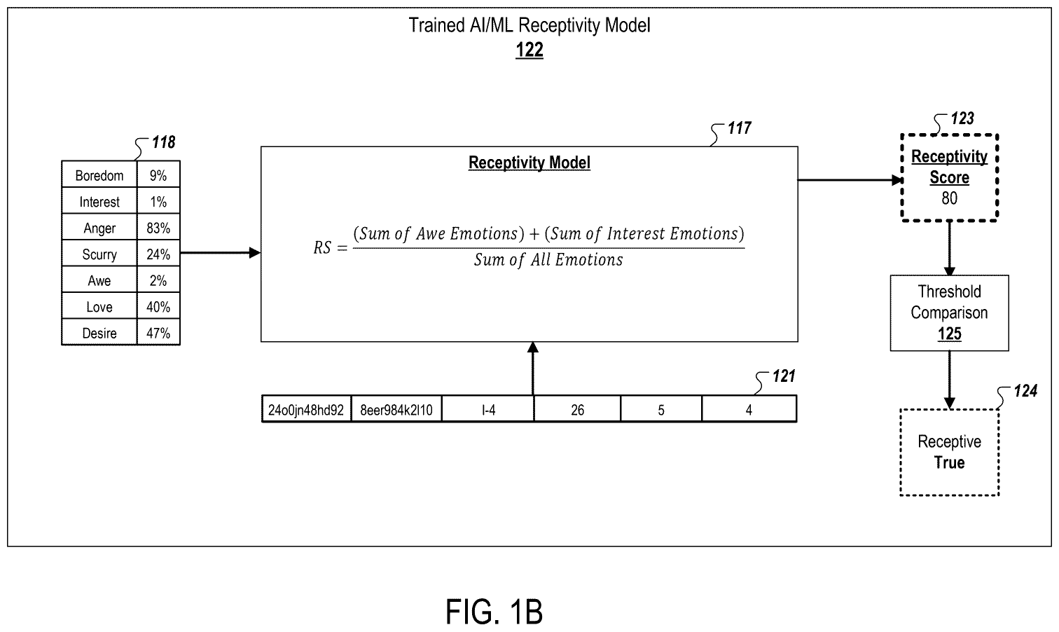

FIG. 1A is a block diagram that illustrates an example of a system 100 for predicting a user's return to a website according to gesture based emotion recognition. The system 100 includes a detection system 103 and a website properties database 120. The detection system 103 can communicate with one or more client devices, such as client device 104, over a network 109. The network 109 can include a wired network, a wireless network, a local network, or an external network, such as the Internet.

Briefly, the detection system 103 can generate a prediction that determines user 102's receptivity to a website displayed on the client device 104. The system can analyze a gesture performed by user 102 on the client device 104 to predict the user's receptivity to the website. For example, specific details related to the gesture detection and analysis can be found in U.S. patent application Ser. No. 15/669,316, the entire contents of which are incorporated herein by reference.

In some implementations, the detection system 103 seeks to predict a user's reception to the website displayed on client device 104 using a user's gesture on the client device 104. By predicting the user's reception to the website based on the user's gesture, the detection system 103 can discover or reveal the intention of the user, or more specifically, what the user's gesture reveals about the user's receptivity with the website. This allows for the detection system 103 to better understand a user's interaction with the website and allows for improving the user's overall experience with the website or with future websites.

The detection system 103 can include one or more servers or computers connected locally or over a network. The system 100 can include a network 109 that can be, for example, local network, a Wi-Fi network, an intranet, an Internet connection, a Bluetooth connection, or some other connection that enables the detection system 103 to communicate, e.g., transmit and receive, with various databases and various computers or client devices.

In some implementations, the detection system 103 can include a website properties database 120. In some implementations, the website properties database 120 may be stored locally or connected to the detection system 103 over network 109. The website properties database 120 can include information associated with the user and the website the user visits. This information can be extracted from the website, calculated, and aggregated over a period of time. For example, the website properties database 120 can include information shown in Table 6 below, for each user's visit to a website. The detection system 103 can acquire data associated with a user's interaction of a website through a respective client device, extract features from the interaction that include the displayed website, and store the extracted features in the website properties database 120.

The world is constantly changing and growing, with wonderful things to learn. Various websites, such as e-learning platforms, have emerged as valuable platforms for continuing education, offering many online courses, and training programs. The online classes provide a flexible environment for studying, breaking down geographical barriers and enabling students to access educational resources globally. However, the shift towards e-learning provides challenges. One notable drawback is the absence of face-to-face interaction. How to improve user receptivity with respect to the website has become the focus of e-learning websites.

In modern data analysis and artificial intelligence (AI), the quest to understand and improve user receptivity has become increasingly important. Through an in-depth study of the impact of diverse content on users, the techniques illustrated with respect to FIG. 1A aim to refine and predict users' receptivity-a measure of user engagement with a website over time. This analysis performed by the processes in system 100 seeks to enhance the appeal of web pages or websites to users, and can play a role in fostering self-discipline and motivation.

In some implementations, the processes performed by system 100 includes using AI modeling to predict users' receptivity, exploring how different types of informational content influence user engagement, and predicting users' receptivity through the use of gesture recognition analysis.

Previous investigations have provided valuable insights into the determinants of user engagement. These studies have scrutinized factors such as content structure, navigational elements, and user interactions to discern their impact on the overall efficacy of online learning experiences. Noteworthy findings emphasize the significance of multimedia integration, content organization, and interactive features in shaping user receptivity. However, each of these factors comes with limitations.

These shortcomings can be addressed by considering the emotions the users experience as they interact with the website, to predict the user's receptivity. Shifting from how users interact with the content to how they feel during the learning process can provide a more comprehensive understanding and a clearer picture of a user's receptivity.

In recent years, websites such as E-learning websites have become popular. But much research has yet to be performed into how online learning platforms capture users' attention. Here, the techniques described with respect to system 100 demonstrates the interaction between website information content, emotional reaction, utilization duration, and user receptivity. The system 100 seeks to identify and analyze the diverse content structures influencing user receptivity within the context of a displayed website and provide actionable recommendations for websites aspiring to enhance user receptivity through AI models. To do this, the system 100 utilizes a non-intrusive approach to measure Users' Receptivity from the emotions they expressed on an website. The system 100 trains and deploys an AI model that predicts a user's receptivity according to diverse content structures shown on the website and their determined emotion. Additionally, the system 100 can automatically generate and provide recommendations to designers and content creators to improve their websites to maximize user receptivity.

In some implementations, the system 100 illustrates and describes the processes with respect to data collection, feature selection, training of the AI/ML model, testing the AI/ML model, and deploying the trained AI/ML model, to name some examples. Other processes are also possible.

In some implementations, the detection system 103 gathers real-time data from a live website using an application programmable interface (API). The API can measures users' emotions when they browse websites by solely analyzing their gestures, e.g., scrolls, swipes, taps, on touchscreen devices. This data is obtained with the user's consent, and the user's privacy is guaranteed.

As illustrated in FIG. 1, user 102 can interact with a website shown on client device 104. The user 102 may perform a gesture 106 on the client device 104 using their finger or fingers. For example, the user 102 may perform gesture 106 by dragging his finger on the touch screen display along a particular path, such as to view a different part of the screen, tap on a GUI element, or resize the screen. The client device 104 may capture and record this gesture 106 as gesture data 108.

The gesture data 108 may include a continuous set of pressure points on the touch screen display over a period of time. For example, the gesture data 108 can include contact points along the touch screen display of client device 104 at specific times. The contact points can additionally include a pressure amount that indicates the pressure at which the user 102 pressed his or her finger or fingers at that point on the touch screen. Additionally, in some cases, the gesture data can include a siteID 107. The siteID 107 includes information that identifies the website being displayed on the client device 104. The siteID 107 may include, for example, a random number, a URL, an IP address of the website, or another identifier for the website. In some cases, the siteID 107 may include information relating to the displayed website. This information can include information the characterizes the website, such as, color scheme, layout, text size, font, and other information shown on the website. The client device 104 can packetize the gesture data 108 and transmit the packetized gesture data 108 over the network 109 to the detection system 103.

Upon receipt of the gesture data 108 from client device 104, the detection system 103 can provide the gesture data 108 to the calibration and normalization module 110. The calibration and normalization module 110 can perform operations that calibrates portions of the gesture data 108 to reflect one or more characteristics of the user and the user's operation of the client device 104. For example, the client device 104 may capture calibration data indicative of a maximum pressure applied to the touchscreen of the client device 104 during a corresponding calibration period, and may transmit the captured calibration data to the detection system 103, which may associate the calibration data with the user 102 and the client device 104, and store the calibration data in the website properties database 120. Other functions of the calibration and normalization module 110 can be found in U.S. patent application Ser. No. 15/669,316.

The calibrated and normalized features are provided to the feature extraction module 112. The feature extraction module 112 can process portions of the calibrated and normalized movement data to derive features that characterize the time-evolving movement of one or more portions of the user 102's body. For example, the feature extraction module 112 may access portions of the normalized positional data and calibrated applied-force data to identifying the normalized, two-dimensional contact positions and calibrated applied-pressure values at each of the discrete detection times. The feature extraction module 112 may, in some instances, compute “micro-differences” in two dimensional positions and applied pressure between each of the discrete detection times, and based on the computed micro-differences, derive values of one or more features that characterize the time-evolving movement of the user's finger during the current collection period. Other functions of the feature extraction module 112 can be found in U.S. patent application Ser. No. 15/669,316.

The feature extraction module 112 can generate time-varying feature data 114. The generated feature data 114 includes data that identifies the derived feature values that characterize the movement of the user's finger at discrete detection times during the current collection, and the detection system 103 can provide the generated feature data 114 as input to a trained AI/ML emotion model 116. The trained AI/ML emotion model 116 can determine, from the generated feature data 114, one or more emotions represented by the free-form movement of the user's finger or fingers, e.g., gesture 106, on the touchscreen of the client device 104. In some examples, the process by which the trained AI/ML emotion model 116 determines one or more emotions using the generated feature data 114 can be found in U.S. patent application Ser. No. 15/669,316.

The trained AI/ML emotion model 116 can generate a set of emotions and a likelihood for each emotion that represents the free-form movement of the gesture 106. For example, the set of emotions can include boredom, interest, anger, scurry, awe, love, and desire, and others. Table 1 illustrated below illustrates a set of emotions and their corresponding descriptions. For example, awe, interest, boredom, and scurry are described in Table 1. These four emotions are descriptive words selection was informed by the observable emotional expressions commonly encountered during web browsing activities. The selection process also accounted for the evolving understanding of emotional states in the context of browsing a web page, incorporating insights from user feedback and empirical observations.

TABLE 1
List of Emotions that Emaww API collects

| Emotion | Description |
|---|---|
| Awe | Awe is a wondrous expression where users become |
| | deeply moved and connected to the content. |
| | They're almost frozen as they absorb new material |
| | that resonates with their interests and captivates |
| | their minds. |
| Interest | When users are interested, they exhibit attentiveness |
| | and curiosity towards the content. They browse |
| | it with enough focus to grasp its meaning. |
| Boredom | Users who are bored have likely reached their maximum |
| | attention span, causing fatigue that leads to |
| | disengagement. As a result, they may become jaded |
| | with the content. |
| Scurry | Scurrying users are preoccupied and completely |
| | disconnected from the content. As they frantically browse, |
| | they exhibit a sense of urgency and rush that corresponds |
| | to a very low level of focus. |

In some cases, the trained AI/ML emotional model 116 can be a Gradient Boosting Classifier. The trained AI/ML emotional model 116 can be trained to produce various emotions, including the emotions outlined in Table 1. The trained AI/ML emotional model 116 can produce the various emotions by leveraging the nine distinct gestures properties from which the model attributes were extracted in Table 2.

Here, the trained AI/ML emotional model 116 can be configured with specific hyperparameter settings tailored to optimize performance. For example, the algorithm's cost complexity pruning alpha is set to 0.001, and the trained AI/ML emotional model 116 utilizes a Friedman mean squared error criterion. The trained AI/ML emotional model 116's initialization was conducted without any specified initializations, and the learning rate was set to 0.1, employing logarithmic loss as the loss function. To control model complexity, the detection system 103 restricted the maximum depth of each tree to 3, and there was no limitation on the number of features.

TABLE 2
List of Gesture Properties For Emotion Prediction

| # | Property | Description |
|---|---|---|
| 1 | Gesture | The time elapsed between the beginning and end |
| | Duration | of the gesture, measured in milliseconds (ms). |
| 2 | Pause | The duration of periods where there is no new |
| | Length | touch event input during the gesture, measured |
| | | in milliseconds (ms). |
| 3 | Touch | The number of distinct touch points registered |
| | Count | during the gesture (unitless). |
| 4 | Gesture | The difference between the maximum and minimum X |
| | Spread | and Y coordinates of touch points during the |
| | | gesture, measured in pixels (px) for both X and |
| | | Y axes. |
| 5 | Gesture | The angle between the initial and final touch points |
| | Direction | relative to a reference axis, measured in degrees |
| | | (°). |
| 6 | Gesture | The total distance covered by the touch points |
| | Travel | during the gesture, considering each movement |
| | | between subsequent touch points, measured in |
| | | pixels (px). |
| 7 | Gesture | The area covered by the touch points during the |
| | Area | gesture, measured in square pixels |
| | | (px²). |
| 8 | Gesture | The average speed of the gesture, calculated by |
| | Speed | dividing the total distance traveled by the gesture |
| | | duration, measured in pixels per second (px/s). |
| 9 | Gesture | The rate of change of gesture speed over time, |
| | Acceleration | estimated by analyzing the change in velocity |
| | | between subsequent time intervals, measured in |
| | | pixels per second squared (px/s²). |

In some implementations, the detection system 103 continuously trains the trained AI/ML emotion model 116. Training can include parameter tuning and algorithmic adjustments.

In some implementations, the trained AI/ML emotional model 116 can output a vector of emotions 118. The vector of emotions 118 includes a likelihood that the gesture data 108 represents the corresponding emotion. Here, the detection system 103 can provide the vector of emotions 118, including the emotions label and the corresponding likelihood to the trained AI/ML receptivity model 122, to produce a receptivity.

In some implementations, the detection system 103 can build training data for the trained AI/ML emotion model 116 and the trained AI/ML receptivity model 122 and store the training data in the website properties database 120. For example, the detection system 103 can build training data by tracking users' interaction with various websites from around the world. In some examples, the detection system 103 tracked for 53 weeks, 6,026 unique users from 35 countries around the world were tracked, and a total of 10,900 browsing sessions were recorded with users' consent. The web pages may be visited by the same user multiple times, with each visit being assigned a unique session ID to indicate a new session. In some cases, to avoid the biases that could occur when a user has already seen the page before, the detection system 103 may consider the sessions related to first time visits to a page. In some cases, the detection system 103 may consider the sessions related to future and subsequent visits to a page to determine user receptivity. Table 3 is a sample showcase of the dataset collected by the detection system 103.

TABLE 3
Structure and Sample Values of the Collected Dataset

| | | | | Page | | | | |
|---|---|---|---|---|---|---|---|---|
| User ID | Session ID | Time | Country | URL | Awe | Interest | Scurry | Boredom |
| 20de5480-7cbf- | d282a40f-0b07- | 2022 Nov. 1 | Canada | Page 1 | 0 | 1 | 0 | 0 |
| 450d-9005- | 447f-9869- | 17:06 | | | | | | |
| 61fb09fdb57f | c4b3c243f5a6 | | | | | | | |
| 21ee131e-55bb- | 12465ae3-9b0b- | 2022 Nov. 6 | South | Page 1 | 1 | 0 | 2 | 0 |
| 477f-9d69- | 45ed-827f- | 22:51 | Korea | | | | | |
| 319bbfa06411 | e703cf3afbc2 | | | | | | | |
| 5a9a7f0e-b19e- | 8b559db8-3399- | 2023 Jan. 26 | France | Page 2 | 1 | 1 | 0 | 0 |
| 4e65-8a28- | 4b82-b4bd- | 19:10 | | | | | | |
| 9dd3babc49bf | 8485fc796876 | | | | | | | |
| 6995805e-a6a9- | 9f96991e-4f21- | 2023 Jun. 28 | Canada | Page 7 | 0 | 2 | 1 | 0 |
| 44e4-92ae- | 41eb-83ca- | 15:42 | | | | | | |
| 3be3a621e6c6 | 1cab1adadedb | | | | | | | |
| 0b74e5c0-2a2c- | ff7fb1e0-29b2- | 2023 Oct. 25 | India | Page 3 | 1 | 2 | 1 | 0 |
| 4090-adb5- | 420e-81c1- | 23:24 | | | | | | |
| 8f574b594f68 | f473d565c8f8 | | | | | | | |

In the structure of the dataset of Table 3, individual rows were generated for each user session. The detection system 103 assigns a User ID to each user, and the detection system assigns a Session ID identified each browsing session. In some cases, the detection system 103 assigns each user and session randomly generated IDs. Page URL is the specific web page address on the website. Time marks the moment a user steps into the e-learning website. Country provides the geographic location of the user. In some cases, the detection system 103 can collect information from users around the world. The data statistics guarantee a diverse range of users, ensuring comprehension of varied user experiences and behaviors across different geographical regions.

In ensuring ethical compliance and transparency in the data collection process, the detection system 103 adheres to full consent protocols and respects the legal frameworks governing data privacy and protection, including the general data protection regulation (GDPR). Throughout the data collection and beyond, the detection system 103 explicitly informs each user about the data collection through cookies with a clearly worded pop-up notification upon their first visit. This notification includes, for example, the nature of the data being collected and its purpose to enhance the user's experience. The notification provides an option for a user to willfully withdraw from the study at any point without affecting their ability to use the website. Specifically, users who do not consent to cookie usage can still browse the e-commerce website untracked, ensuring their browsing experience remained wholly unaffected by data collection procedures.

In some implementations, the detection system 103 relies on a non-intrusive approach to measure user receptivity to websites. In order to measure user receptivity, the trained AI/ML receptivity model 122 processes not only the emotions of the user 102 interacting with the website but also extracted features from the website itself.

For example, each website includes its own content. In order to retrieve this content, the detection system 103 can transmit an instruction to the client device 104 to perform web scraping of the displayed website. Thus, when the client device 104 transmits the gesture data 108 to the detection system 103, the client device 104 incorporates the scraped website information into the gesture data 108. For example, a website may include various information, include many pages, and different information on each page. An e-learning website may have 7 pages, for example. Each page has affluent information content and different layouts. In order to gather quantitative data about web page properties, the detection system 103 can employ a web scraping approach. The web scraping approach can be performed using two libraries, for example. These libraries include “requests” and “BeautifulSoup,” both of which facilitate the extraction of specific information from web pages. In doing so, the libraries converted every URL to HTML files. For HTML content retrieval, the function “count_colors (html_content)” is used to figure out how many different colors were used on each page. This function analyzes the code to find all the color information. Similarly, the function “count_images (html_content)” to count how many images were on each page by scanning through the code for image tags. The function “count_paragraphs (html_content)” counts the number of paragraphs on each page by searching for paragraph tags in the code. In some implementations, the client device 104 performs the web scraping process and provides the scraped information back to the detection system 103 for storage in the website properties database 120. In some implementations, the detection system 103 performs the web scraping process by scraping the website using the URL provided in the siteID 107 from the client device 104.

In some implementations, the detection system 103 can extract data from various websites and incorporate the extracted information as inputs into the trained AI/ML receptivity model 122. The extracted information can include, for example, the number of colors, number of images, and number of paragraphs per page, to name a few examples. Table 4 shows web pages features information:

TABLE 4
Basic Web Pages (features) Information

| Page | Number of | Number of | Number of |
|---|---|---|---|
| URL | Colors | Images | Paragraphs |
| Page1 | 38 | 7 | 6 |
| Page2 | 31 | 7 | 8 |
| Page3 | 26 | 5 | 4 |
| Page4 | 25 | 1 | 5 |
| Page5 | 29 | 9 | 10 |
| Page6 | 28 | 8 | 3 |
| Page7 | 32 | 8 | 9 |

In some implementations, the detection system 103 divided the average 24 hours of a day into 8 intervals, as shown in Table 5 below. In some cases, a particular time of day can affect users receptivity. For example, a user may be more receptive to a website after breakfast than in the middle of the night because they are more alert and awake.

TABLE 5
Intervals of Time within 24 Hours

| Intervals | Start Time | End Time |
|---|---|---|
| I-1 | 00:01 | 03:00 |
| I-2 | 03:01 | 06:00 |
| I-3 | 06:01 | 09:00 |
| I-4 | 09:01 | 12:00 |
| I-5 | 12:01 | 15:00 |
| I-6 | 15:01 | 18:00 |
| I-7 | 18:01 | 21:00 |
| I-8 | 21:01 | 00:00 |

In some implementations, the detection system 103 can process the vector of emotions 118 and the selected data from the website properties database 120 to produce a receptivity output. FIG. 1B, which more specifically illustrates processes performed by the trained AI/ML receptivity model 122 to predict a user's receptivity to a website. In FIG. 1B, “receptivity” is defined as the output of the trained AI/ML receptivity model 122. In some examples, receptivity can be a binary variable with two values-True or False. The binary variable is determined by the Receptivity Score (RS). For example, the trained AI/ML receptivity model 122 produces a value of “True” if the Receptivity Score satisfies a threshold value, and produces a value of “False” if the Receptivity Score does not satisfy the threshold value. For example, the threshold value may be 75%, or higher.

In some implementations, the term “receptivity” refers to a machine learning likelihood or probability of a user that is cognitively or emotionally open to engaging with, attending to, interacting with, or responding in a positive manner to a website or its content. Receptivity is derived from one or more detected emotional gestures. An intensity or amount of the receptivity is defined by the Receptivity score. The Receptivity Score represents the ratio of highly receptive emotions to all emotions expressed within a session, as described in the formula below in equation 1:

$$RS = \frac{( Sum of Awe Emotions ) + ( Sum of Interest Emotions )}{Sum of All Emotions} \qquad ( 1 )$$

In some examples, as illustrated in FIG. 1B, the trained AI/ML receptivity model 122 processes the vector of emotions 118. The receptivity model 117 can use equation 1 above to calculate a receptivity score. In some examples, the receptivity model 117 can use the vector of emotions 118 and the website properties 121 extracted from the website properties database 120 using the siteID 107 as index. Here, the receptivity model 117 can receive the vector of emotions 118 and the website properties 121 as input, and output a receptivity score 123. As shown in the example of FIG. 1B, the receptivity score 123 is 80. However, other scores are also possible.

Feature selection involves calculating users' receptivity labeled as output. Extracting web pages' properties and time intervals labeled as input variables. Table 6 shows the features and a sample of values.

TABLE 6
The Features and a Sample of Values.

| | Session | Time | Number | Number | Number of | Receptivity | Receptive |
|---|---|---|---|---|---|---|---|
| User ID | ID | Interval | of Colors | of Images | Paragraphs | Score(%) | (the Output) |
| 20de5480- | d282a40f- | I-6 | 38 | 7 | 6 | 100% | True |
| 7cbf-450d- | 0b07- | | | | | | |
| 9005- | 447f- | | | | | | |
| 61fb09fdb57f | 9869- | | | | | | |
| | c4b3c243f5a6 | | | | | | |
| 21ee131e- | 12465ae3- | I-8 | 38 | 7 | 6 | 33.3% | False |
| 55bb-477f- | 9b0b- | | | | | | |
| 9d69- | 45ed- | | | | | | |
| 319bbfa06411 | 827f- | | | | | | |
| | e703cf3afbc2 | | | | | | |
| 5a9a7f0e- | 8b559db8- | I-7 | 31 | 7 | 8 | 100% | True |
| b19e-4e65- | 3399- | | | | | | |
| 8a28- | 4b82- | | | | | | |
| 9dd3babc49bf | b4bd- | | | | | | |
| | 8485fc796876 | | | | | | |
| 6995805e- | 9f96991e- | I-6 | 32 | 8 | 9 | 66.7% | False |
| a6a9-44e4- | 4f21- | | | | | | |
| 92ae- | 41eb- | | | | | | |
| 3be3a621e6c6 | 83ca- | | | | | | |
| | 1cab1adadedb | | | | | | |
| 0b74e5c0- | ff7fb1e0- | I-8 | 26 | 5 | 4 | 75% | True |
| 2a2c-4090- | 29b2- | | | | | | |
| adb5- | 420e- | | | | | | |
| 8f574b594f68 | 81c1- | | | | | | |
| | f473d565c8f8 | | | | | | |

In some implementations, the trained AI/ML receptivity model 122 performs a threshold comparison 125 between the receptivity score 123 and a threshold value. If the receptivity score 123 satisfies, e.g., exceeds or meets, the threshold value, then the trained AI/ML receptivity model 122 outputs a receptivity value 124 of “True”, otherwise, the trained AI/ML receptivity score 122 outputs a receptivity value 124 of “False.”

In some implementations, the detection system 103 can select a threshold value for determining whether the user is receptive to a website on a number of factors. For example, the selection of a 70% threshold for determining the model output to be “True” or “False” is grounded in a balanced consideration of practicality, performance standards, and educational objectives. The selection of a 70% threshold represents a clear and easily understandable benchmark, facilitating a straightforward interpretation of learner performance. Aligned with established performance standards and industry norms, achieving a score of 70% signifies a level of competency or mastery in the subject matter, reflecting a solid understanding of the material. However, other threshold values are also possible.

In response, the trained AI/ML receptivity model 122 can process the inputs and generate an output 124. The output 124 can include, for example, a binary decision that indicates either (i) True, the corresponding user is receptive to the website or (ii) False, the corresponding user is not receptive to the website. In some cases, the detection system 103 can provide the output 124 to a developer of the site, to a third-party company, and/or to the client device 104. The output 124 can be provided as reporting information 126, which can include information showing how the detection system 103 arrived at its output 124. This information can include, for example, data identifying the time-varying feature data 114, the vector of emotions 118, the calculated receptivity score 123, and the data 123 selected from the website properties database 120.

In some implementations, the detection system 103 can select from various machine learning models to use for the trained AI/ML receptivity model 122. In particular, the detection system 103 can utilize a diverse set of algorithms known for their applicability across various domains. In some examples, Quadratic Discriminant Analysis (QDA) can be included for its ability to model complex decision boundaries. In some examples, Support Vector Machine (SVM) can be included for its efficacy in handling high-dimensional data and nonlinear relationships. In some examples, K-Nearest Neighbors (KNN) is included for its simplicity and adaptability to different types of data. Decision Tree, XGBoost, Random Forest, Extra Trees, and Light Gradient Boosting Machine are all selected for their strengths in handling complex relationships and providing robust predictions through ensemble techniques. The detection system 103 can select from each of these models to use as the trained AI/ML receptivity model 122.

The detection system 103 can evaluate each of these models using a set of standard metrics that collectively capture their performance across different dimensions. Accuracy, a fundamental metric, provides an overall measure of correct predictions. Recall emphasizes the model's ability to identify positive instances, precision gauges the accuracy of positive predictions, and the F1 score balances the trade-off between precision and recall. By employing this suite of evaluation metrics, the detection system 103 attempts to assess the models' performance, considering not only the model's ability to make accurate predictions but also the model's capacity to handle imbalances in the dataset and strike an optimal balance between precision and recall, which can be useful for applications with varying degrees of cost associated with false positives and false negatives. The careful choice of both algorithms and evaluation metrics is pivotal in ensuring a robust and insightful analysis of our research findings.

Table 7 below illustrates a comparison of the evaluation metrics for each machine learning model that underwent training and validation, in some examples.

TABLE 7
Accuracy of different algorithms

| | | | | F1 |
|---|---|---|---|---|
| Algorithm | Accuracy | Recall | Precision | Score |
| Quadratic Discriminant | 43.12% | 0.4312 | 0.7091 | 0.5025 |
| Analysis | | | | |
| SVM | 75.5% | 0.7557 | 0.7204 | 0.7312 |
| KNN | 81.02% | 0.8102 | 0.7286 | 0.7570 |
| Decision Tree | 82.85% | 0.8285 | 0.7145 | 0.7570 |
| XGBoost | 82.88% | 0.8288 | 0.6962 | 0.7543 |
| Random Forest | 82.92% | 0.8292 | 0.7052 | 0.7562 |
| Extra Trees | 82.92% | 0.8292 | 0.7180 | 0.7574 |
| Light Gradient Boosting | 83.20% | 0.8320 | 0.6912 | 0.7601 |
| Machine | | | | |

As shown in Table 7, in some examples, Quadratic Discriminant Analysis (QDA) demonstrates an accuracy of greater than 40%, e.g., such as 43.12%, with a recall of 0.4312 and precision of 0.7091, suggesting challenges in achieving a balance between true positives and false positives. The Support Vector Machine (SVM) stands out with a higher accuracy of greater than 70%, e.g., such as 75.5%, coupled with commendable recall (0.7557) and precision (0.7204), indicating a balanced performance in positive predictions and precision. K-Nearest Neighbors (KNN) exhibits a notable accuracy of greater than 80%, e.g., such as 81.02%, with high recall (0.8102) and a reasonable precision of 0.7286, reflecting effectiveness in accurate positive predictions while maintaining precision.

The Decision Tree model achieves an accuracy of greater than 80%, e.g., such as 82.85%, with a high recall of 0.8285. However, a potential trade-off between precision (0.7145) and recall is evident. Notably, XGBoost, Random Forest, and Extra Trees models display comparable performances with accuracies around 82-83%, showcasing varying precision and F1 scores. A nuanced assessment is important based on the specific requirements of the task. In some cases, the Light Gradient Boosting Machine (LightGBM) emerges as the top-performing model, boasting the highest accuracy of greater than 82%, e.g., such as 83.20%. Despite a slightly lower precision (0.6912), the F1 score of 0.7601 suggests a well-balanced trade-off between precision and recall, positioning LightGBM as a promising candidate for the given task. The choice of the desired model should, however, be guided by the specific objectives and trade-offs relevant to the task at hand.

In some cases, the detection system 103 may include or exclude time from the features as input to the trained AI/ML receptivity model 122. The decision to exclude time from the features during training can result in a high accuracy (e.g., above 80%, such as 82% as an example), which is a metric commonly used to assess model performance. However, the model can suffer from a pronounced overfitting issue, manifesting as an exclusive prediction of a single class. In the absence of the time feature, the model exhibited a propensity to overfit by fixating on patterns that were possibly transient or specific to certain temporal segments within the dataset. The overfitting phenomenon is detrimental to the model's reliability in real-world scenarios, as it compromises the generalizability of learned patterns to different temporal contexts. By introducing time as an input feature, the model gains the capacity to discern and incorporate temporal dynamics inherent in the data. This temporal awareness enables the model to better adapt to evolving patterns over time and mitigates the risk of overfitting specific temporal idiosyncrasies present in the training dataset.

The inclusion of time as an input feature serves as a regularizer that guides the model towards learning more robust and generalizable patterns. This, in turn, enhances the model's ability to make accurate predictions across diverse temporal contexts, making it an important factor in eliminating the major overfitting problem encountered in previous approaches.

In some cases, the detection system 103 can train each of the models using 10-fold cross-validation, with a diverse set of algorithms selected for analysis. The results showed that the Light Gradient Boosting Machine (LightGBM) performed the best, with an accuracy of greater than 82%, e.g., such as 83.20%. Time was found to be an important input feature, as excluding it led to overfitting issues. Incorporating time as a feature enhanced the model's ability to generalize and make accurate predictions. As a result, the detection system 103 can incorporate the LightGBM as the trained AI/ML receptivity model 122 for processing the vector of emotions 118 and the website properties 121.

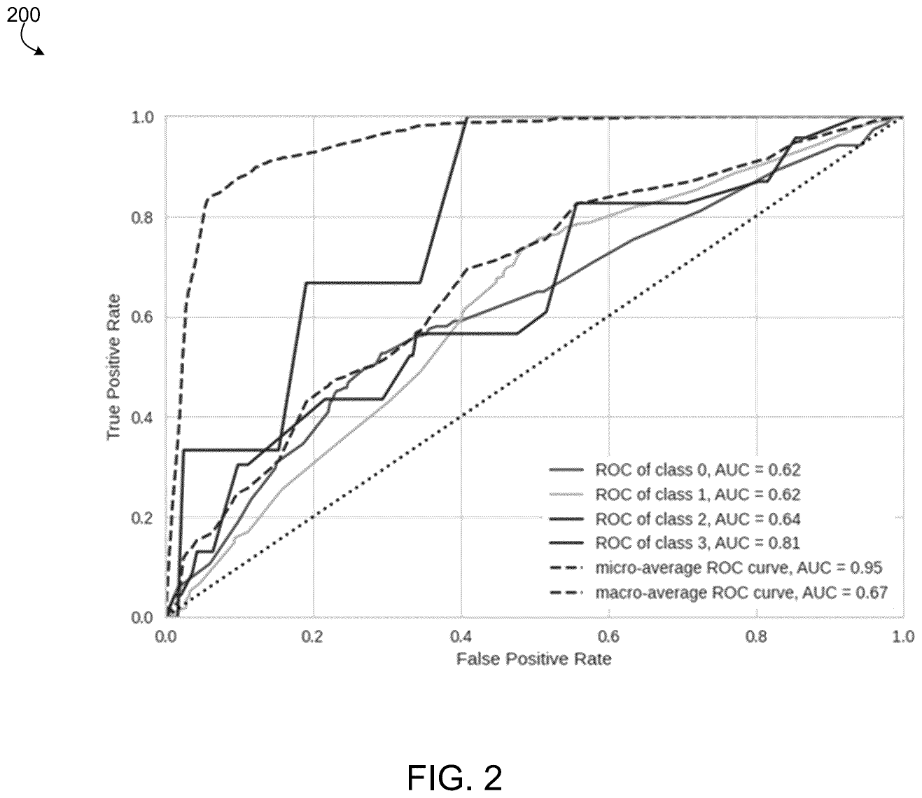

For example, the Light GBM has an accuracy of greater than 83%, e.g., such as 83.20%, which is the maximum among the 8 algorithms. FIG. 2 illustrates the receiver operating characteristic (ROC) curves for each class and their area under curve (AUC) for each class validated from the light gradient boosting algorithm. In some cases, the detection system 103 can set the threshold for binary classification at 0.7 in order to optimize accuracy in predicting whether users are receptive or distracted. By selecting this threshold, the detection system 103 attempts to ensure higher accuracy levels for content creators in the when identifying users who are receptive to their website content. The chosen threshold of 0.7 is strategically determined to strike a balance, allowing for an acceptable threshold dilution of up to 30%, which can provide a reasonable trade-off between precision and recall in the classification task. However, the detection system 103 can select other threshold values.

In summary, the detection system 103 analyzes and predicts users' receptivity based on the web page attributes and the corresponding emotion gesture recognition. The detection system 103 can extract the physical properties of each page of a website, which can include the number of colors, number of images, and number of paragraphs alongside the start time of each browsing session of each user, for example. Standard machine learning models were chosen to train with the dataset. Among them, the Light Gradient Boosting Machine algorithm resulted in the highest accuracy with 83.20%. This model can be thus implemented in analyzing and predicting the receptivity of a user based on the web page attributes and time. The detection system 103 can provide the vector of emotions 118 and the scraped information for a current webpage 121 as input to the trained AI/ML receptivity model 122 to produce a receptivity score output.

As a result, the detection system 103 can generate a receptivity score derived from web page attributes, serving as a valuable resource for UI/UX designers. By providing insights into user engagement levels, these findings empower designers to craft web pages with a meticulous layout, which can enhance the ability to captivate and maintain user focus on the content. For example, the detection system 103 can generate recommendations to include in the reporting information 126 for improving a website's layout, color scheme, or other, in order to improve future receptivity scores for the website. Consequently, these findings can be integrated into design practices as a guiding principle to optimize user experience and overall web page effectiveness.

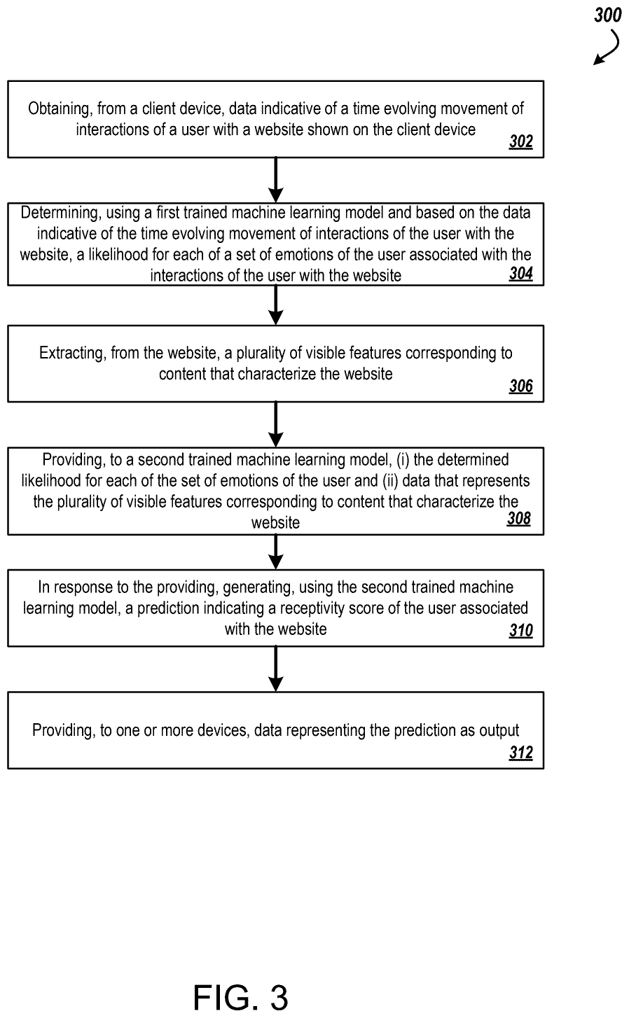

FIG. 3 is a flow diagram that illustrates an example of a process 300 for prediction a return to a website according to gesture based emotion recognition. A detection system, such as detection system 103, can perform the process 300.

During 302, the detection system obtains, from a client device, data indicative of a time evolving movement of interactions of a user with a website shown on the client device. Obtaining the data includes the detection system determining normalized and calibrated values for the data indicative of the time evolving movement. The system can generate feature values that characterize the normalized values. For example, the generated feature values include at least one of speed, acceleration, contract duration, a change in contact pressure, or a finger size. Moreover, the detection system can obtain the data indicative of the time evolving movement of a portion of a body of the user with the interactive site shown the client device, and the portion of the body includes a finger and the client device includes a touchscreen display. Here, the data indicative of the time evolving movement includes a plurality of contacts established sequentially between a finger of the user and a surface of a touchscreen display of the client device at corresponding contact times, wherein the plurality of contacts includes contact positions, contact pressures, and the contact times associated with each of the contacts.

During 304, the detection system determines, using a first trained machine learning model and based on the data indicative of the time evolving movement of interactions of the user with the website, a likelihood for each of a set of emotions of the user associated with the interactions of the user with the website. The detection system provides the data indicative of the time evolving movement of the user as input to the first machine learning model. The first machine learning model generates an output that is a metric of the user emotion. The detection system obtains, from the first trained machine learning model, a vector that includes a plurality of emotions and a likelihood for each emotion of the plurality of emotions. The likelihood for each emotion represents how likely a corresponding emotion represents that data indicative of the time evolving movement of the user.

During 306, the detection system extracts, from the website, a plurality of visible features the characterize the website. Extracting the plurality of visible features includes the detection system extracting, from the website, a number of colors, a number of images, a number of paragraphs, and a number of words from the website. This information can also include a user identifier (ID), a session ID, and a time interval. The time interval includes a time of day for when the user interacted with the website. The detection system can store, in a database, the number of colors, the number of images, the number of paragraphs, the number of words for the website, the user ID, the session ID, and the time interval. More specifically, extracting the information from the website includes the detecting system parsing, from the interactive site, Hypertext Markup Language (HTML) using a scraper to retrieve the number of colors, the number of images, the number of paragraphs, and the number of words.

During 308, the detection system provides, to a second trained machine learning model, (i) the determined likelihood for each of the set of emotions of the user and (ii) data that represents the plurality of visible features corresponding to content that characterize the website. The second trained machine learning model includes a Light Gradient Boosting Machine. For example, the detection system provides, to the Light Gradient Boosting Machine, (i) the determined likelihood for each of the set of emotions of the user and (ii) the data that represents the plurality of visible features corresponding to content that characterize the website.

During 310, in response to the providing, the detection system generates, using the second trained machine learning model, a prediction indicating a receptivity score of the user associated with the website. Here, the detection system generates, using the second trained machine learning model, a receptivity score that indicates the likelihood that the user is receptive to content displayed on the website. The detection system compares the receptivity score to a threshold value and determines whether the receptivity score satisfies the threshold value. In response to determining that the receptivity score satisfies the threshold value, the detection system classifies the user's interaction with the website as receptive or a value of “True”. Or, in response to determining that the receptivity score does not satisfy the threshold value, the detection system classifies the user's interaction with the website as non-receptive or a value of “False”. Here, the detection system generates, using the second trained machine learning model, a prediction indicating the likelihood that the user is receptive to the interactive site includes the detection system generating, using the second trained machine learning model, the prediction indicating the receptivity score that the user is receptive to the website during a single user session with the website.

During 312, the detection system provides, to one or more devices, data representing the prediction as output. In some cases, the one or more devices can be separate devices from the client device that provided the data indicative of the time evolving movement of the user. The one or more devices can be devices associated with a developer, a third party, or another party. In some cases, the one or more devices can include the client device that provided the data indicative of the time evolving movement of the user.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification), or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining, from a client device, data indicative of a time evolving movement of interactions of a user with a website shown on the client device;
determining, using a first trained machine learning model and based on the data indicative of the time evolving movement of interactions of the user with the website, a likelihood for each of a set of emotions of the user associated with the interactions of the user with the website;
extracting, from the website, a plurality of visible features corresponding to content that characterize the website;
providing, to a second trained machine learning model, (i) the determined likelihood for each of the set of emotions of the user and (ii) data that represents the plurality of visible features corresponding to content that characterize the website;
in response to the providing, generating, using the second trained machine learning model, a prediction indicating a receptivity score of the user associated with the website; and
providing, to one or more devices, data representing the prediction as output.

2. The computer-implemented method of claim 1, wherein obtaining the data indicative of the time evolving movement of interactions of the user with the website shown on the client device further comprises:
determining normalized values for the data indicative of the time evolving movement; and
generating feature values that characterize the normalized values, wherein the generated feature values comprise at least one of speed, acceleration, contact duration, a change in contact pressure, or a finger size.

3. The computer-implemented method of claim 1, wherein obtaining the data indicative of the time evolving movement of interactions of the user with the website shown on the client device further comprises:
obtaining, from the client device, the data indicative of the time evolving movement of a portion of a body of the user with the website shown on the client device,
wherein the portion of the body comprises a finger and the client device comprises a touchscreen display.

4. The computer-implemented method of claim 1, wherein determining, using a first trained machine learning model and based on the data indicative of the time evolving movement of interactions of the user with the website, a likelihood for each of a set of emotions of the user associated with the interactions of the user with the website comprises obtaining, from the first trained machine learning model, a vector that comprises a plurality of emotions and the likelihood for each emotion of the plurality of emotions, wherein each likelihood represents how likely a corresponding emotion represents the data indicative of the time evolving movement of the user.

5. The computer-implemented method of claim 1, wherein extracting, from the website, a plurality of visible features that characterize the website comprises:
extracting, from the website, a number of colors, a number of images, a number of paragraphs, and number of words; and
storing, in a database, the number of colors, the number of images, the number of paragraphs, and the number of words for the website.

6. The computer-implemented method of claim 5, wherein extracting, from the website, a number of colors, a number of images, a number of paragraphs, and number of words comprises parsing, from the website, Hypertext Markup Language (HTML) using a scraper to retrieve the number of colors, the number of images, the number of paragraphs, and the number of words.

7. The computer-implemented method of claim 1, wherein the second trained machine learning model comprises a Light Gradient Boosting Machine.

8. The computer-implemented method of claim 1, wherein generating, using the second trained machine learning model, a prediction indicating a receptivity score of the user associated with the website comprises:
generating, using the second trained machine learning model, the receptivity score that indicates the likelihood that the user is receptive to content displayed on the website;
comparing the receptivity score to a threshold value;
determining whether the receptivity score satisfies the threshold value; and
in response to determining that the receptivity score satisfies the threshold value, classifying the user's interaction with the website as receptive; or
in response to determining that the receptivity score does not satisfy the threshold value, classifying the user's interaction with the website as non-receptive.

9. The computer-implemented method of claim 8, wherein generating, using the second trained machine learning model, a prediction indicating a receptivity score of the user associated with the website comprises generating, using the second trained machine learning model, the prediction indicating the receptivity score that the user is receptive to the website during a single user session with the website.

10. The computer-implemented method of claim 1, wherein the data that represents the plurality of visible features that characterize the website comprises (i) a user ID, (ii) a session ID, (iii) a time interval, (iv) a number of colors on the website, (v) a number of images on the website, (vi) a number of paragraphs on the website, and (vii) a number of words on the website.

11. The computer-implemented method of claim 10, wherein the time interval comprises a time of day for when the user interacted with the website.

12. The computer-implemented method of claim 1, wherein the data indicative of the time evolving movement comprises a plurality of contacts established sequentially between a finger of the user and a surface of a touchscreen display of the client device at corresponding contact times, wherein the plurality of contacts comprises contact positions, contact pressures, and the contact times associated with each of the contacts.

13. A system comprising:
one or more computers and one or more storage devices storing instructions that are operable, when executed by the one or more computers, to cause the one or more computers to perform operations comprising:
obtaining, from a client device, data indicative of a time evolving movement of interactions of a user with website shown on the client device;
determining, using a first trained machine learning model and based on the data indicative of the time evolving movement of interactions of the user with the website, a likelihood for each of a set of emotions of the user associated with the interactions of the user with the website;
extracting, from the website, a plurality of visible features corresponding to content that characterize the website;
providing, to a second trained machine learning model, (i) the determined likelihood for each of the set of emotions of the user and (ii) data that represents the plurality of visible features corresponding to content that characterize the website;
in response to the providing, generating, using the second trained machine learning model, a prediction indicating a receptivity score of the user associated with the website; and
providing, to one or more devices, data representing the prediction as output.

14. The system of claim 13, wherein obtaining the data indicative of the time evolving movement of the user with the website shown on the client device further comprises:
determining normalized values for the data indicative of the time evolving movement; and
generating feature values that characterize the normalized values, wherein the generated feature values comprise at least one of speed, acceleration, contact duration, a change in contact pressure, or a finger size.

15. The system of claim 13, wherein obtaining the data indicative of the time evolving movement of the user with the website shown on the client device further comprises:
obtaining, from the client device, the data indicative of the time evolving movement of a portion of a body of the user with the website shown on the client device,
wherein the portion of the body comprises a finger and the client device comprises a touchscreen display.

16. The system of claim 13, wherein determining, using a first trained machine learning model and based on the data indicative of the time evolving movement of interactions of the user with the website, a likelihood for each of a set of emotions of the user associated with the interactions of the user with the website comprises obtaining, from the first trained machine learning model, a vector that comprises a plurality of emotions and the likelihood for each emotion of the plurality of emotions, wherein each likelihood represents how likely a corresponding emotion represents the data indicative of the time evolving movement of the user.

17. The system of claim 13, wherein extracting, from the website, a plurality of visible features that characterize the website comprises:
extracting, from the website, a number of colors, a number of images, a number of paragraphs, and number of words; and
storing, in a database, the number of colors, the number of images, the number of paragraphs, and the number of words for the website.

18. The system of claim 17, wherein extracting, from the website, a number of colors, a number of images, a number of paragraphs, and number of words comprises parsing, from the website, Hypertext Markup Language (HTML) using a scraper to retrieve the number of colors, the number of images, the number of paragraphs, and the number of words.

19. The system of claim 13, wherein the second trained machine learning model comprises a Light Gradient Boosting Machine.

20. A non-transitory computer-readable medium storing software comprising instructions executable by one or more computers which, upon such execution, cause the one or more computers to perform operations comprising:
obtaining, from a client device, data indicative of a time evolving movement of interactions of a user with website shown on the client device;
determining, using a first trained machine learning model and based on the data indicative of the time evolving movement of interactions of the user with the website, a likelihood for each of a set of emotions of the user associated with the interactions of the user with the website;
extracting, from the website, a plurality of visible features corresponding to content that characterize the website;
providing, to a second trained machine learning model, (i) the determined likelihood for each of the set of emotions of the user and (ii) data that represents the plurality of visible features corresponding to content that characterize the website;
in response to the providing, generating, using the second trained machine learning model, a prediction indicating a receptivity score of the user associated with the website; and
providing, to one or more devices, data representing the prediction as output.
